(19) United States
(12) Patent Application Publication
(10) Pub. No.: US 2015/0030230 A1
(43) Pub. Date: Jan. 29, 2015

(54) SUBSTRATE INSPECTION METHOD, SUBSTRATE MANUFACTURING METHOD AND SUBSTRATE INSPECTION DEVICE

(71) Applicant: HOYA CORPORATION, Tokyo (JP)

(72) Inventor: Masaru TANABE, Shinjuku-ku (JP)

(73) Assignee: HOYA CORPORATION, Tokyo (JP)

(21) Appl. No.: 14/306,952

(22) Filed: Jun. 17, 2014

(30) Foreign Application Priority Data
Jul. 26, 2013 (JP) 2013-156155

(51) Int. Cl. G06T 7/00; G01N 21/95

(52) U.S. Cl. CPC G06T 7/001; G01N 21/9501; G06T 2207/30148
USPC 382/149

(57) ABSTRACT

A method for inspecting a substrate having a plurality of holes formed on a plate-shaped material so as to extend over front and rear surfaces thereof. The method comprises picking-up an image of a plurality of holes formed on the substrate by imaging from one surface side of the substrate and obtaining a hole image of each hole (S103). Then, specifying a reference hole image of the plurality of holes from an imaging result obtained by the image acquisition step (S105). Thereafter, a similarity between each hole image, being the imaging result obtained by the image acquisition step is quantified and the reference hole image, is obtained by pattern matching processing using a specific correlative function (S105 to S107). Finally, a proper/improper hole shape of each of the plurality of holes is judged using a quantification result of each hole image obtained by the quantification step as an index (S108).

### BACKGROUND

1. Technical Field

The present invention relates to a substrate inspection method for performing inspection to a substrate having a plurality of holes, a substrate manufacturing method passing through the inspection, and a substrate inspection device used for the inspection.

2. Description of Related Art

For example, regarding a substrate having a plurality of hole such as via holes and through holes, etc., it is general that presence/absence of defect of each hole is inspected in the manufacturing process of the substrate. The defect shows an abnormal state such as an abnormal hole shape, foreign matters in a hole portion, scratches in the hole portion, positional deviation of a hole center, etc. The same thing can be said for the substrate utilized as a liquid discharging nozzle used for an ink jet head other than a printed circuit board, if the substrate has a plurality of holes. Thus, as a technique of inspecting the substrate having a plurality of holes, the following case is known: for example, a size, etc., of each hole is specified by utilizing a hole image picked-up by an imaging device, and each specification result is compared with design data, to thereby inspect presence/absence of a defect (for example, see patent documents 1 and 2).

Further, in recent years, use of a photosensitive glass is proposed as a base material for constituting a printed circuit board (for example see patent document 5). The photosensitive glass is configured so that selective etching by hydrogen fluoride (HF) can be applied only to a photosensitive portion by exposure, and is made of a material realizing a micro-processing while utilizing the property of glass. If the photosensitive glass is used, a micro-processing technique such as a photolithography technique can be utilized, and therefore a smaller diameter of each formed hole or higher density, etc., can be easily realized. The substrate thus formed by forming a plurality of holes on the photosensitive glass, can be utilized as an interposer being a lamination structure substrate on which a semiconductor device is mounted, an integrated passive device (IPD), a liquid discharge nozzle used for an ink jet head, and a substrate for electronic amplification constituting a gas electronic amplifier (GEM), other than the printed circuit board.

### PRIOR ART DOCUMENT

### Patent Document

Patent document 1: Japanese Patent Laid Open Publication No. 2003-194522
Patent document 2: Japanese Patent Laid Open Publication No. 2011-163802
Patent document 3: Patent Publication No. 3756041

Incidentally, regarding the substrate having a plurality of holes formed on the photosensitive glass, a hole size becomes finer to 100 μm or less, and a total number of holes are progressively increased as the size of the substrate is increased, which is increased as the hole size becomes finer. Therefore, when presence/absence of the defect of each hole is examined using a conventional inspection technique, there is a problem as follows.

For example, when the hole size becomes finer to 100 μm or less, it becomes difficult to form the hole shape as desired, and there is a high possibility that deformation (distortion, etc.) is generated in the hole shape. However, in a conventional inspection technique, even if each hole size (for example, diameter size), etc., can be inspected, presence/absence of the deformation of the hole shape cannot be objectively and quantitatively judged. Meanwhile, it is estimated that individual hole center position coordinate is deviated at random, due to thermal expansion caused by a variation of temperature during exposure work for creating a through hole, and abnormal drawing stage, etc.

Meanwhile, for example, when the hole size becomes finer to 100 μm or less, the hole image matching exactly an actual hole shape cannot be necessarily picked-up under an influence of an image magnification or a limit in resolution of an optical system, resulting in an ambiguous imaging result of the hole image. Therefore, defect inspection is not always performed with high precision, even if such an ambiguous imaging result is compared with design data. Also, even if the hole image is picked-up by observation with high magnification to thereby obtain further clear image, it is not practical to observe and judge the total number of hundreds of thousands or more of holes, with high magnification. Meanwhile, it is not easy to obtain individual hole coordinate from a deformed hole shape.

Namely, regarding the substrate to be inspected, the hole shape and the hole central position coordinate cannot be always easily, clearly, and speedily inspected with high precision by a conventional inspection technique, in consideration of the fact that when the hole size becomes finer to 100 μm or less, the size of the substrate is simultaneously increased, and the total number of holes is also increased.

Therefore, an object of the present invention is to provide a substrate inspection method, a substrate manufacturing method, and a substrate inspection device for the substrate having a plurality of holes, capable of speedily and precisely inspecting the defect of each hole, and capable of easily and clearly inspecting the defect, even in a case that the total number of holes is progressively increased due to finer hole size and increase in the size of the substrate.

In order to achieve the abovementioned object, the present invention is provided.

According to a first aspect of the present invention, there is provided a substrate inspection method, for inspecting a substrate having a plurality of holes formed on a plate-shaped material so as to extend over front and rear surfaces of the plate-shaped material, including:

an image acquisition step of picking-up an image of a plurality of holes formed on the substrate by imaging from one surface side of the substrate, and obtaining a hole image of each hole;

a reference specification step of specifying a reference hole image of the plurality of holes from an imaging result obtained by the image acquisition step;

a quantification step of obtaining and quantifying a similarity between each hole image being the imaging result obtained by the image acquisition step, and the reference hole image, by pattern matching processing using a specific correlative function; and

a shape inspection step of judging proper/improper hole shape of each of the plurality of holes using a quantification result of each hole image obtained by the quantification step as an index.

According to a second aspect of the present invention, there is provided the substrate inspection method of the first aspect, further including a size inspection step of obtaining a hole outline of each hole image by fitting processing, the hole image being the imaging result obtained by the image acquisition step, and making a proper/improper judgment for at least one of a hole size and a hole shape position of each of the plurality of holes, using the hole outline.

According to a third aspect of the present invention, there is provided the substrate inspection method of the first aspect, wherein the substrate has the holes formed on a plate-shaped photosensitive glass material with a thickness of 1 mm or less, and the holes are through holes or conductive material filling holes with a diameter of 100 μm or less.

According to a fourth aspect of the present invention, there is provided the substrate inspection method of the first aspect, wherein when the image of the plurality of holes are picked-up via an optical system including a microscope having an objective lens of a specific magnification in the image acquisition step, super resolution image processing is applied to the hole image obtained by the image acquisition step, to thereby obtain a super resolution image corresponding to an image picked-up via an optical system including a microscope having an objective lens of higher magnification than the specific magnification, as the imaging result obtained by the image acquisition step.

According to a fifth aspect of the present invention, there is provided a substrate manufacturing method, including:

a substrate formation step of constituting a substrate having a plurality of holes formed on a plate-shaped material so as to extend over front rear surfaces of the plate-shaped material;

an image acquisition step of obtaining a hole image of each hole by imaging the plurality of holes formed on the substrate from one surface side of the substrate constituted in the substrate formation step;

a reference specification step of specifying a reference hole image of the plurality of holes from an imaging result obtained by the image acquisition step;

a quantification step of obtaining and quantifying a similarity between each hole image and the reference hole image, each hole image being the imaging result obtained by the image acquisition step by pattern matching processing using a specific correlative function; and

a formation inspection step of judging proper/improper hole shape of each of the plurality of holes using a quantification result of each hole image obtained by the quantification step as an index.

According to a sixth aspect of the present invention, there is provided the substrate manufacturing method of the fifth aspect, further comprising a size inspection step of obtaining a hole outline of each hole image by fitting processing, the hole image being the imaging result obtained by the image acquisition step, and making a proper/improper judgment for at least one of a hole size and a hole shape position of each of the plurality of holes, using the hole outline.

According to a seventh aspect of the present invention, there is provided the substrate manufacturing method of the fifth aspect, wherein the substrate has the holes formed on a plate-shaped photosensitive glass material with a thickness of 1 mm or less, and the holes are through holes or conductive material filling holes with a diameter of 100 μm or less.

According to an eighth aspect of the present invention, there is provided the substrate manufacturing method of the fifth aspect, wherein when the image of the plurality of holes are picked-up via an optical system including a microscope having an objective lens of a specific magnification in the image acquisition step, super resolution image processing is applied to the hole image obtained by the image acquisition step, to thereby obtain a super resolution image corresponding to an image picked-up via an optical system including a microscope having an objective lens of higher magnification than the specific magnification, as the imaging result obtained by the image acquisition step.

According to a ninth aspect of the present invention, there is provided a substrate inspection device for inspecting a substrate having a plurality of holes formed on a plate-shaped material so as to extend over front and rear surfaces of the plate-shaped material, the device including:

an image acquisition unit configured to obtain a hole image of each hole by imaging the plurality of holes formed on the substrate from one surface side of the substrate;

a reference specification unit configured to specify a reference hole image of the plurality of holes from an imaging result obtained by the image acquisition unit;

a quantification unit configured to obtain and quantify a similarity between each hole image and the reference hole image by pattern matching processing using a specific correlative function, each hole image being the imaging result obtained by the image acquisition unit; and

a shape inspection unit configured to judge proper/improper hole shape of each of the plurality of holes using a quantification result of each hole image obtained by the quantification unit as an index.

According to a tenth aspect of the present invention, there is provided the substrate inspection device of the ninth aspect, further comprising a size inspection unit of obtaining a hole outline of each hole image by fitting processing, the hole image being the imaging result obtained by the image acquisition unit, and making a proper/improper judgment for at least one of a hole size and a hole shape position of each of the plurality of holes, using the hole outline.

According to an eleventh aspect of the present invention, there is provided the substrate inspection device of the ninth aspect, wherein the substrate has the holes formed on a plate-shaped photosensitive glass material with a thickness of 1 mm or less, and the holes are through holes or conductive material filling holes with a diameter of 100 μm or less.

According to a twelve aspect of the present invention, there is provided the substrate inspection device of the ninth aspect, wherein when the image of the plurality of holes are picked-up via an optical system including a microscope having an objective lens of a specific magnification in the image acquisition unit, super resolution image processing is applied to the hole image obtained by the image acquisition unit, to thereby obtain a super resolution image corresponding to an image picked-up via an optical system including a microscope having an objective lens of higher magnification than the specific magnification, as the imaging result obtained by the image acquisition unit.

According to the present invention, regarding the substrate having a plurality of holes, the defect of each hole can be inspected speedily and precisely, and the defect can be inspected easily, clearly, and speedily even in a case that the total number of holes is progressively increased due to finer hole size and increase in the size of the substrate.

### BRIEF DESCRIPTION OF THE DRAWINGS

FIG. 1 is a block diagram showing an example of a functional structure of a substrate inspection device according to the present invention.

FIG. 2 is a flowchart showing an example of a processing procedure of a substrate inspection method according to the present invention.

FIG. 3 is an explanatory view showing a specific example of super resolution image processing.

FIG. 4 is an explanatory view showing a specific example of edge specification and circular fitting.

FIG. 5 is an explanatory view showing a specific example of a display output aspect of a judgment result of a proper or improper hole image.

### DETAILED DESCRIPTION OF THE INVENTION

An embodiment of the present invention will be described hereafter, based on the drawings.

1. Substrate to be inspection
2. Constitutional example of a substrate inspection device
3. Procedure of a substrate inspection method
4. Procedure of a substrate manufacturing method
5. Effect of this embodiment
6. Modified example, etc.

### 1. Substrate to be Inspected

A substrate to be inspected in this embodiment will be described first.

### (Basic Structure)

The substrate to be inspected in this embodiment is constituted having a plurality of holes formed on a plate-shaped material as a base material, so as to be two-dimensionally arranged. Namely, a plurality of holes are formed on the plate-shaped material constituting the substrate, extending over front and rear surfaces thereof so as to be regularly arranged on a planar surface. Each hole formed on the plate-shaped material may be a through hole or may be a conductive material filling hole formed by filling the through hole with a conductive material. Further, regarding the substrate to be inspected, a through hole portion may be observed by a microscope as described below, and therefore if the through hole is exposed, front and rear surfaces of the plate-shaped material may be covered with metal, etc.

Further, as the plate-shaped material being the base material of the substrate to be inspected, it can be considered that a photosensitive glass is used, which is configured so that selective etching can be applied only to a photosensitive portion by exposure using hydrogen fluoride (HF), and so that a hole size becomes finer and holes are arranged at finer pitch, which is difficult by a mechanical processing such as a fine powder jetting method, etc., for example.

The “photosensitive glass” is the glass obtained by including small quantity of Au, Ag, Cu as photosensitive metals, and further CeO₂ as a sensitizer, in SiO₂—Li₂O—Al₂O₃-based glass. The photosensitive glass causes an oxidation-reduction reaction, thereby generating metal atoms, by irradiating the glass with UV rays. Further, if the photosensitive glass is heated, the metal atoms are agglutinated to form a colloid, and crystal of Li₂O.SiO₂ (metasilic acid lithium) grows, using the collide as a crystal nucleus. Li₂O.SiO₂ (metasilic acid lithium) precipitated here is easily dissolved in HF, and there is about 50 times of difference in a dissolving speed, compared with the glass portion not irradiated with UV-rays. The selective etching is enabled by utilizing such a difference of the dissolving speed, and a fine processed material can be formed without using mechanical processing. As such a photosensitive glass, for example “PEG3 (product name)” by HOYA Corporation can be given.

Note that the photosensitive glass for forming the plate-shaped material, is not necessarily the “PEG3”, and it can be considered that the plate-shaped material can be formed by other photosensitive glass. As other photosensitive glass, a photosensitive crystallized glass obtained by crystallizing the photosensitive glass can be given as an example of the photosensitive glass.

The “photosensitive crystallized glass” is the glass obtained by precipitating a fine crystal uniformly in the glass by applying heat treatment to the photosensitive glass (heat treatment under a condition different from the condition in the case of applying fine processing to the photosensitive glass). The crystal precipitated here has excellent chemical durability, unlike the crystal of Li₂O.SiO₂ (metasilic acid lithium). Accordingly, the photosensitive crystallized glass is in a polycrystalline state in which crystallization is completely accelerated, and has an advantage of having excellent mechanical property compared with the photosensitive glass which is a noncrystalline solid. As such a photosensitive crystallized glass, for example “PEG3C (product name)” by HOYA Corporation can be given.

The substrate thus having a plurality of holes formed on the photosensitive glass, can be utilized as a printed circuit board, an interposer, an integrated passive device (IPD), a liquid discharge nozzle of an ink jet head, and a substrate for electronic amplification constituting a gas electronic amplifier (GEM).

(A Specific Example of the Substrate)

In this embodiment, as a specific example of the substrate to be inspected, the following substrate can be given.

For example, the photosensitive glass with 1 mm thickness and 200 mm square made of PEG3 is prepared as the plate-shaped material being a base material. Then, laser exposure, crystallization of the photosensitive portion by annealing at 600° C., and dissolution by fluorine-based etchant are performed to the plate-shaped material, to thereby form circular through holes having a hole size of 100 μm at 200 μm pitch, thus constituting the substrate to be inspected.

The plate-shaped material having the through holes, may be subjected to further heat treatment, so that the photosensitive crystallized glass made of PEG3C may be formed.

As the substrate to be inspected in this embodiment, the following substrate can be given as other specific example.

For example, the photosensitive glass having 15 mm thickness and 200 square made of PEG3C is prepared as the plate-shaped material being the base material. Then, laser exposure, crystallization of the photosensitive portion by annealing at 600° C., and dissolution by fluorine-based etchant are performed to the plate-shaped material, to thereby form circular through holes having a hole size of 100 μm at 200 μm pitch, thus constituting the substrate to be inspected.

The plate-shaped material having the through holes, may be subjected to further heat treatment, so that the photosensitive crystallized glass made of PEG3C may be formed. Thereafter, inside of each through hole provided on the plate-shaped material is filled with a conductive member made of Cu by an electroplating method. Then, the front and rear surfaces of the substrate are polished to remove Cu on the surface portion to thereby obtain a desired plate thickness, thus constituting the substrate having conductive member filling holes on the plate-shaped material, as the substrate to be inspected.

As described above, in this embodiment, the substrate made of a plate-shaped photosensitive glass material having a plate thickness of 1 mm or less, and having the through holes or conductive member filling holes having a diameter of 100 μm or less, can be the substrate to be inspected. However, each substrate given here is simply a specific example, and it is a matter of course that the substrate to be inspected in this embodiment is not limited thereto, particularly regarding the plate-shaped material and a formation size of the hole, etc.

### 2. Constitutional Example of a Substrate Inspection Device

A constitutional example of the substrate inspection device used for inspecting the abovementioned substrate, will be described next.

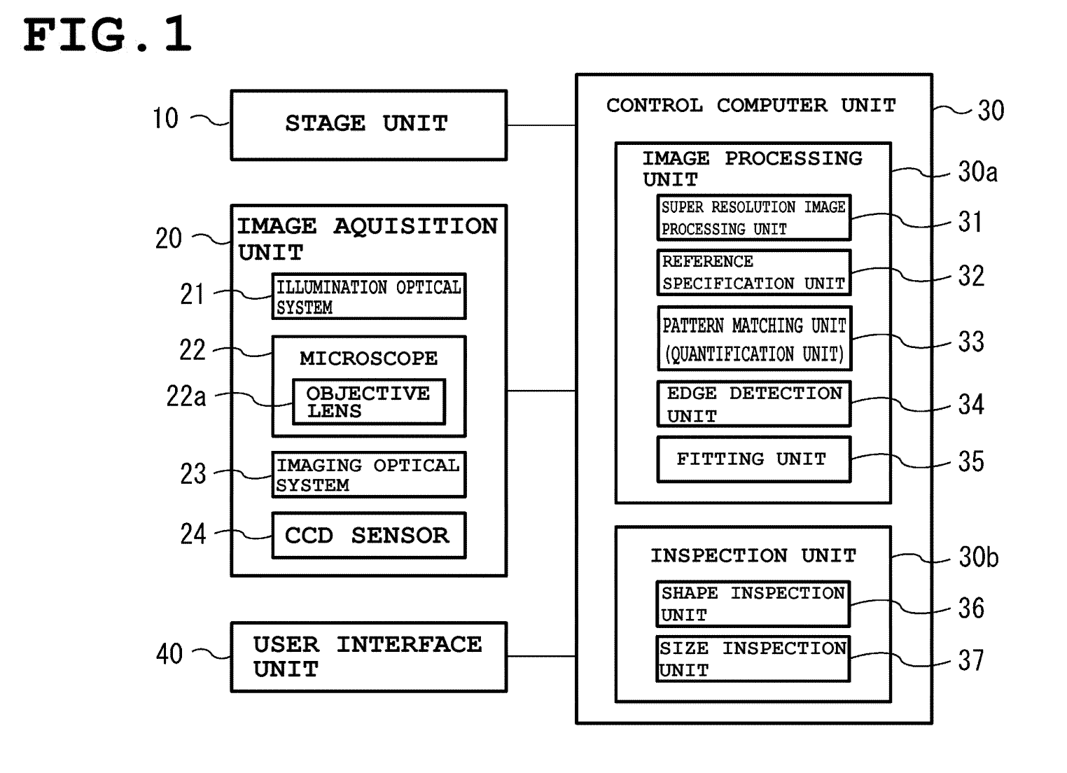

FIG. 1 is a block diagram showing an example of a functional structure of the substrate inspection device according to the present invention.

As shown in the figure, the substrate inspection device described in this embodiment is roughly constituted of a stage unit 10, an image acquisition unit 20; a control computer unit 30; and a user interface unit 40.

(Stage Unit)

A stage unit 10 is a stage on which the substrate to be inspected is set. It can be considered that setting of the substrate is performed, for example, by placing the substrate on a table provided in the stage unit 10, or by fixing the substrate by vacuum suction, etc. However, the setting of the substrate is not limited thereto, and other publicly-known technique can also be utilized.

Further, the stage unit 10 is constituted so that the substrate is moved in each direction of X, Y, Z, θ for example, to thereby move a relative position between the set substrate and an image acquisition unit 20 described later. Then, regarding each direction of X, Y, Z, θ, coordinates of at least X-direction and Y-direction “namely each direction along a substrate plane) can be managed with high precision by a laser interferometer for example.

Although relative positional movement is realized by moving the side of the image acquisition unit 20, a moving mechanism is preferably provided to the stage unit 10 in consideration of simplifying a device structure and a higher precision, etc., of the relative positional movement.

(Image Acquisition Unit)

The image acquisition unit 20 is configured to pick-up and obtain an image of a hole (through hole or conductive member filling hole) formed on the substrate, from one surface side of the substrate. At this time, one surface side of the substrate to be imaged, is preferably a lower surface side when the substrate is set on the stage unit 10. This is because the lower surface side would suppress adhesion of foreign matters such as dust, etc., to an imaged surface when the image is picked-up.

In order to pick-up the hole image, the image acquisition unit 20 has an illumination optical system 21; a microscope 22; an imaging optical system 23; and CCD (Charge Coupled Device) sensor 24.

The illumination optical system 21 is configured to irradiate the substrate to be inspected, with light required for picking-up the hole image. It can be considered that the illumination optical system 21 is used as a reflection optical system. However, the illumination optical system 21 may be a transmission optical system or a dark field optical system. As an irradiation light by the illumination optical system 21, it can be considered that the light by a light emitting diode of blue color having a wavelength of 488 nm is used for example. However, the present invention is not limited thereto, and other light may also be used.

The microscope 22 realizes magnified observation of a partial area on an imaged surface, regarding the imaged surface of the substrate to be inspected. Therefore, the microscope 22 has an objective lens 22a of a specific magnification. Note that the objective lens 22a of the specific magnification is the lens with low magnification of 5 to 20 magnifying powers. Specifically, each objective lens 22a of 5 magnifying powers, 10 magnifying powers, and 20 magnifying powers may be mounted on a lens revolver, or any one of these objective lenses alone (for example the objective lens of 5 magnifying powers) may be mounted on the lens revolver.

The imaging optical system 23 is configured to guide an optical image expanded by the microscope 22, to the CCD sensor 24, and performs focusing of the optical image on the imaging surface of the CCD sensor 24.

The CCD sensor 24 is configured to pick-up the hole image in the substrate to be inspected by receiving the light obtained via the microscope 22 and the imaging optical system 23. However, the CCD sensor 24 is configured to pick-up the hole image through the microscope 22, and therefore regarding a part of the area on the imaging surface of the substrate to be inspected, the CCD sensor 24 picks-up the image of the hole image that exists in this area. Note that although the CCD sensor 24 is suitable for picking-up the image in relatively a static state, TDI camera may also be used, which is suitable for picking-up the image in a scanning state and is synchronized with drive of the stage.

(Control Computer Unit)

The control computer unit 30 is configured to control an operation in the substrate inspection device. Specifically, the control computer unit 30 is composed of a combination of CPU (Central Processing Unit), RAM (Random Access Memory), ROM (Read Only Memory), HDD (Hard disk drive), and each kind of interface, etc. Then, the control computer unit 30 is configured to cause the CPU to perform each kind of control operation by executing a specific program stored in the ROM or HDD. For example, the control computer unit 30 is configured to function as an image processing unit 30a and an inspection unit 30b by executing a specific program by CPU.

(Image Processing Unit)

The image processing unit 30a is configured to perform specific image processing to the hole image which is a result of picking-up the image by the CCD sensor 24. As the specific image processing performed by the image processing unit 30a, the following processing can be given.

Namely, in order to perform specific image processing, the image processing unit 30a functions as a super resolution image processing unit 31; a reference specification unit 32; a pattern matching unit (quantification unit) 33; an edge detection unit 34; and a fitting unit 35. Then, as the specific image processing, the super resolution image processing unit 31 performs super resolution image processing to the hole image, the reference specification unit 32 performs processing of specifying a reference hole image, the pattern matching unit 33 performs pattern matching processing for matching patterns of each hole image and the reference hole image after super resolution image processing performed by the pattern matching unit 33, the edge detection unit 34 performs processing of specifying an edge of each hole image that matches the reference hole image, and the fitting unit 35 performs fitting processing for specifying an outline of the hole from the edge specified by the fitting unit 35. Note that details of these processing will be described later.

(Detection Unit)

The detection unit 30b is configured to detect the proper or improper hole formed on the substrate to be inspected, using the result of the image processing performed by the image processing unit 30a. As the inspection performed by the inspection unit 30b, the following inspection can be given.

Namely, the inspection unit 30b functions as a shape inspection unit 36 and a size inspection unit 37, for inspecting the hole formed on the substrate. Then, regarding the substrate to be inspected, the shape inspection unit 36 judges the proper or improper hole shape of each hole, and the size inspection unit 37 judges proper or improper hole size of each hole and a hole central position coordinate (position accuracy). Details of the processing for the proper or improper judgment will be described later.

The specific program for realizing each function 31 to 37 in the control computer unit 30 described above, is used by being installed in the control computer unit 30. However, prior to the install, the program may be stored in a computer readable memory medium read by the control computer unit 30 and then may be provided, or may be provided to the control computer unit 30 through a communication line connecting to the control computer unit 30.

Further, the control computer unit 30 is not necessarily mounted on the substrate inspection device, if it can control the operation in the substrate inspection device, and may be connected to the substrate inspection device via the communication line.

(User Interface Unit)

The user interface unit 40 is configured to input/output information to an operator of the substrate inspection device as needed. Therefore, the user interface unit 40 is configured to have a display device such as a liquid crystal panel or an operation panel.

### 3. Procedure of the Substrate Inspection Method

Substrate inspection processing performed using the substrate inspection device configured as described above, namely an example of the processing procedure of the substrate inspection method according to the present invention will be described next.

(Outline of the Processing Procedure)

Here, an outline of the processing procedure of the substrate inspection method will be described first.

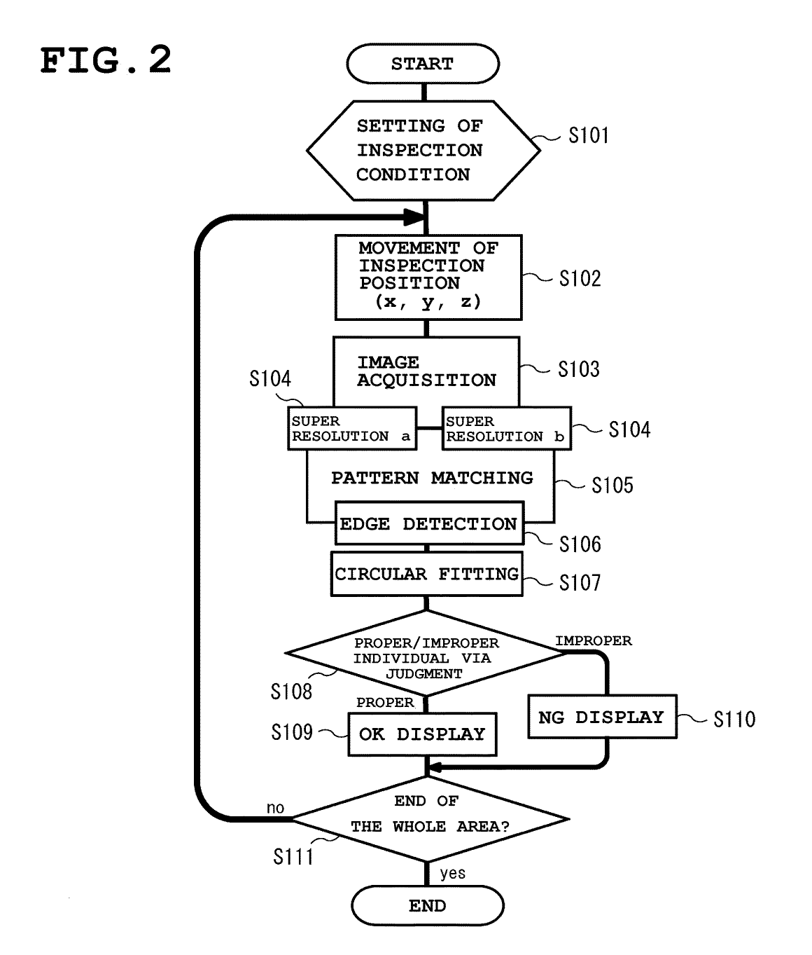

FIG. 2 is a flowchart showing an example of the processing procedure of the substrate inspection method according to the present invention.

When the inspection of the substrate is performed using the substrate inspection device, the control computer unit 30 controls to perform setting of an inspecting condition (step 101, the step is abbreviated as “S” hereafter). The setting of the inspecting condition may be performed by the operator of the substrate inspection device through the operation of the user interface unit 40. As the inspecting condition set here, the following condition can be given.

Namely, in a case of a mechanical system of performing relative positional movement by the stage unit 10, the inspection condition includes a speed at the time of the relative positional movement, acceleration, and a static standby time, etc. Further, in a case of the optical system in the image acquisition unit 20 for example, the inspection condition includes an optical magnification of the objective lens 22a selected when the objective lens has the lens revolver, illumination luminance by the illumination optical system 21, and exposure time, etc.

Further, for example, in a case of the image processing performed by the image processing unit 30a, the processing includes kernel and algorithm used by the super resolution image processing unit 31, a specification reference of a reference hole image used by the pattern matching unit, an edge specification reference used by the edge detection unit 34, and a fitting reference used by the fitting unit 35, or the like. Details of the inspection condition regarding these image processing will be described later.

Further, the inspection condition of the information processing system includes data content, etc., stored after inspection.

When the inspection condition is set, the control computer unit 30 gives a moving instruction to the stage unit 10 thereafter, and controls the relative position between the substrate and the image acquisition unit 20 to move (S102) so that the image acquisition unit 20 can picks-up the image of a part of the area on the substrate to be inspected. In this stage, rotation matching to match a reference coordinate axis and original coordinate setting are performed for the substrate or the pattern. Such a work is not necessarily performed for each imaging, and may be performed before the first imaging. Then, when the movement of the stage unit 10 is completed, the image acquisition unit 20 picks-up the image in a part of the area, to thereby obtain the hole image in this part of the area (S103).

When the hole image is obtained, in the image processing unit 30a, the super resolution image processing unit 31 performs super resolution image processing to the hole image (S104), and after the reference specification unit 32 specifies the reference hole image, the pattern matching unit 33 performs pattern matching of each hole image and the reference hole image after the super resolution image processing (S105), and the edge detection unit 34 performs processing of specifying the edge of each hole image (S106), and the fitting unit 35 performs fitting processing of specifying the outline of the hole from the specified edge (S107).

Thereafter, the inspection unit 30b inspects proper or improper hole (via) formed on the substrate while using the result of the image processing by the image processing unit 30a (S108). Then, if the result is “proper”, OK display showing the proper is performed by the user interface unit 40 (S109), and if the result is “improper”, NG display is performed by the user interface unit 40 (S110).

The substrate inspection device repeatedly performs such a series of processing until other part of the area on the substrate is ended completely (S102 to S111).

Each step in such a series of processing will be more specifically described hereafter based on a specific example.

(S102: Inspection Positional Movement)

As already described above, the image acquisition unit 20 carries out expanding observation for a part of the area on the substrate via the microscope 22. Therefore, the imaged surface on the substrate is divided into a plurality of partial areas, and pick-up of the hole image is sequentially performed to each of the partial areas. Namely, when the stage unit 10 is moved, X-coordinate value and Y-coordinate value after movement are specified so that a plurality of partial areas on the substrate are sequentially selected to be imaged. Note that the content regarding a moving order, etc., between areas is not particularly limited, if it is previously set.

Incidentally, in this embodiment, the objective lens 22a provided in the microscope 22, is a lens having a low magnification of 5 to 20 magnifying powers. Accordingly, as described above, even in a case that the imaged surface on the substrate is divided into a plurality of partial areas, the number of the divided areas may be small, compared with a case that the objective lens of a high magnification of 40 to 100 magnifying powers is used. Namely, in this embodiment, by interposing the objective lens 22a of a low magnification, it is possible to suppress sudden narrowing of an inspectable visual field area, compared with a case of a high magnification, and therefore faster speed of the inspection time is realized by suppressing the increase of the number of the partial areas to be imaged.

(S103: Acquisition of Image)

When the movement of the stage unit 10 is completed, in the image acquisition unit 20, a part of the area on the substrate to be imaged is irradiated with light by the illumination optical system 21, and the light obtained from the part of the area by such an irradiation, is received by the CCD sensor 24 via the microscope 22 and the imaging optical system 23.

At this time, in the microscope 22 interposed between the substrate and the CCD sensor 24, the objective lens 22a of a low magnification of 5 to 20 magnifying powers can be used, and therefore observation by a small lens numerical aperture (NA) is enabled, compared with a case that the objective lens of a high magnification of 40 to 100 magnifying powers is interposed. For example, in a case of the objective lens 22a of 5 magnifying powers, NA=about 0.15 may be satisfactory, and if the NA is small, the observation is enabled with a deeper focal depth of the optical system. Namely, in this embodiment, the focal depth can be suppressed from becoming shallow by interposing the objective lens 22a of low magnification, and therefore allowance can be increased for blurring of the hole image as a result of imaging, compared with a case of high magnification. Accordingly, it is not necessary to add a high-precision autofocus mechanism to the imaging optical system 23, thus not inviting increase in a size of the optical system or increase in a cost. Further, by suppressing the focal depth from becoming shallow, it is possible to flexibly and suitably cope with the difference of the kind of the hole such as a through hole or a conductive member filling hole (via hole), etc. Namely, high precise defect inspection can be performed, irrespective of the kind of the hole formed on the substrate.

If the image is thus acquired, in a part of the area on the substrate to be imaged, each hole image as a result of imaging, which exists in this part is outputted to the control computer unit 30. In the control computer unit 30, the shape and the size, etc., of each hole are grasped by analyzing the outputted each hole image.

(S104: Super Resolution)

Incidentally, if the objective lens 22a of the microscope 22 has low magnification of 5 to 20 magnifying powers, there is a risk of generating a situation that a progress of finer hole size is not necessarily sufficiently responded, compared with a case that the objective lens of high magnification of 40 to 100 magnifying powers is interposed.

In this embodiment, when the image acquisition unit picks-up the image in a part of the area on the substrate via the microscope 22 having the objective lens 22a of low magnification of 5 to 20 magnifying powers to compensate the abovementioned risk, and obtains the hole image in this part of the area, the super resolution image processing unit 31 in the image processing unit 30a applies super resolution image processing to the hole image.

Here, the “super resolution image processing” is one of a digital image processing technique, and means the processing for obtaining a high precision image by realizing a high resolution of the inputted image. According to such a super resolution image processing, the picked-up image with blurring or distortion can be restored to an original high precision image.

Generally, the optical system including the microscope 22 is used as an important mathematical model whose characteristic is shown by Point Spread Function (abbreviated as “PSF” hereafter). Namely, the picked-up image obtained via the microscope 22 includes blurring or distortion, etc., caused by the PSF. However, such a blurring or distortion, etc., can be calculated by numerical operation called convolution (convolution operation) by using the PSF. This is the operation of restoring the original high precision image or removing the blurring or distortion, etc., from the image and PSF having blurring or distortion, etc., by carrying out an inverse operation to the convolution (deconvolution operation).

In the super resolution image processing performed by the super resolution image processing unit 31, the higher precision image than the picked-up image obtained by the image acquisition unit 20 can be obtained, by carrying out the deconvolution using the abovementioned PSF. More specifically, the deconvolution operation using the PSF is carried out by the image acquisition unit 20 for the hole image picked-up via the microscope 22 having the objective lens 22a of low magnification of 5 to 20 magnifying powers, to thereby obtain the image corresponding to the picked-up image via the optical system including the microscope having the objective lens of high magnification of 40 to 100 magnifying powers. The image obtained by the super resolution image processing is called a “super resolution image” hereafter.

In order to suitably carry out the deconvolution operation, the super resolution image processing unit can respond to a plurality of kinds of operation algorithms and is configured to respond to a plurality of kinds of PSF kernel sizes.

The operation algorithm is provided for specifying the content of the deconvolution operation. For example, as one of the operation algorithms, a “Wiener filter” is known. Spatial frequency characteristic of the Wiener filter is expressed by the following formula (1).

$$\begin{matrix}[ Formula 1 ] & \\ WF ( u , v ) = \frac{{H}^{*} ( u , v )}{{\vert H ( u , v ) \vert}^{2} + {S}_{n} ( u , v ) / {S}_{f} ( u , v )} & ( 1 )\end{matrix}$$

In Formula (1), H*(u, v) indicates complex conjugate, and S_{f}(u, v) and Sₙ(u, v) indicate an original image and a power spectrum of noise respectively. A second term of a denominator of formula (1) indicates a ratio of noise to signal of a deteriorated image, and generally such a second term is not known. Therefore a suitable constant is substituted into the second term so that the hole image is restored. Wherein, if the second term is 0, the formula (1) shows a simple inverse filter.

As the operation algorithm, for example, the following kinds can be given other than the Wiener filter: “DampedLS”, “Tikhonov”, “TSVD”, “TotalVariati (TotalVariation), “Hybrid”, “SteepestDes (SteepestDescent)”, “RichardsonL (RichardsonLucy)” etc.

Further, the PSF kernel size is provided for specifying the size of the PSF to be used. For example, as the kernel size, Gaussian kernel in the following number of matrixes is considered to be used: kernel size 1:matrix of 3 pixels×3 pixels, kernel size 2: matrix of 5 pixels×5 pixels, kernel size 3: matrix of 7 pixels×7 pixels, kernel size 4: matrix of 9 pixels×9 pixels, and kernel size 5: matrix of 11 pixels×11 pixels.

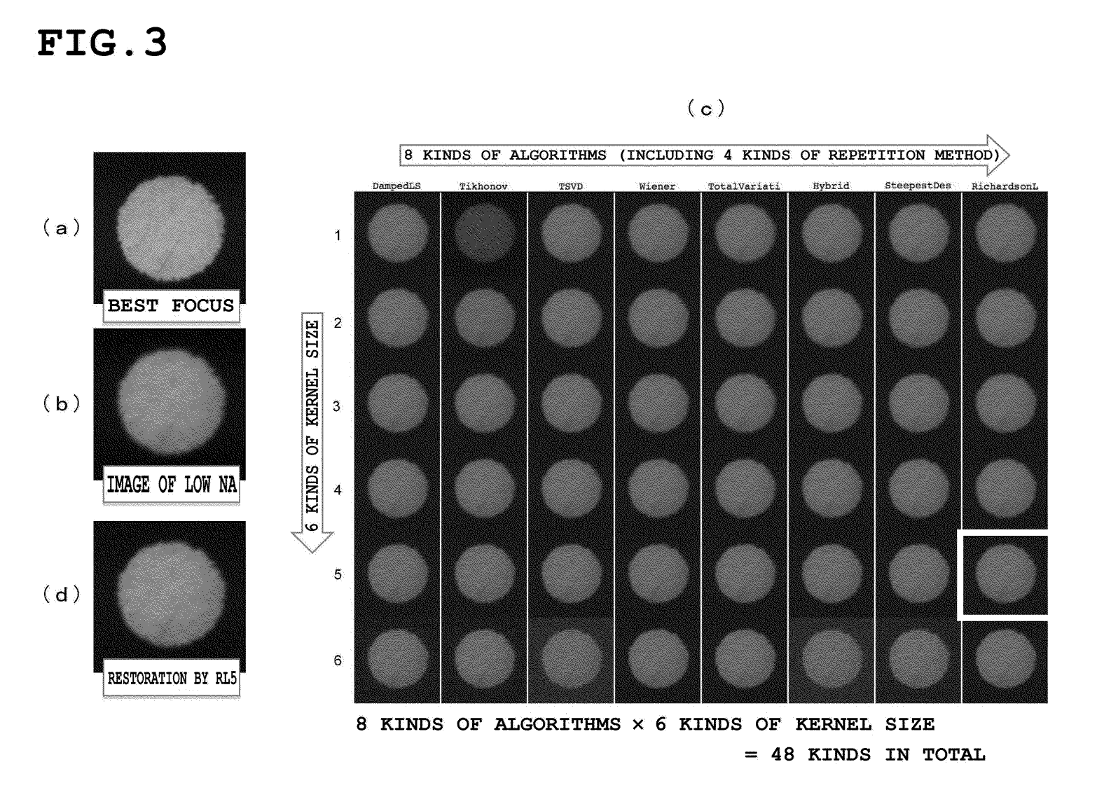

FIG. 3 is an explanatory view showing a specific example of the super resolution image processing.

Here, super resolution image processing is given for example, which is performed in a case that imaging is performed via the objective lens 22a of low magnification (for example, 5 magnifying powers) and low NA (for example NA=0.15), to the hole on the substrate where the hole image shown in FIG. 3A is obtained in a case of a best focus when the image is picked-up via the objective lens of high magnification (for example, 50 magnifying powers), to thereby obtain the hole image, and FIG. 3B shows an example of the super resolution image processing applied to this hole image.

In order to apply super resolution image processing to the hole image shown in FIG. 3B, the super resolution image processing unit 31 is configured to respond to 8 kinds of operation algorithms and respond to 6 kinds of PSF kernel sizes as shown in FIG. 3C. Namely, the super resolution image processing unit 31 is configured to perform super resolution image processing using one or a plurality of the following operation algorithms and the kernel sizes: 8 kinds of operation algorithms×6 kinds of kernel sizes=48 kinds in total.

A combination of the operation algorithm and the kernel size used for performing super resolution image processing, is specified at the time of setting the inspection condition (see S101 in FIG. 2). The kind of the combination specified at the time of setting the inspection condition, is not necessarily one, and there may be a plurality of kinds of the combination. When a plurality of kinds of the combination are specified, the super resolution image processing unit 31 performs each kind of super resolution image processing sequentially or in parallel to each other (see “super resolution a” and “super resolution b” in FIG. 2). Note that “a plurality of kinds” specified here also includes a case that all of the 48 kinds in total are specified.

When the super resolution image processing unit 31 applies super resolution image processing to the hole image shown in FIG. 3B, for example, the super resolution image shown in FIG. 3D is obtained when using the combination (RL5) of the operation algorithm and the kernel size 5 of “RichardsonL (RichardsonLucy)”. According to the super resolution image shown in FIG. 3D, high resolution is realized to solve the blurring or distortion that exists in the original hole image shown in FIG. 3B, to thereby restore the image in a state close to the hole image shown in FIG. 3A, namely in a state of the original high precision image, and therefore a detection precision is secured, which is required for the inspection performed thereafter.

When there a plurality of numbers of holes to be inspected, for example, it can be considered that a suitable super resolution processing is set, which is then mechanically applied to the whole body of the holes. In the setting of the suitable super resolution processing, for example a super resolution processing technique of obtaining an ideal image close to an image picked-up in a best focus condition may be narrowed down to one kind or several kinds, for the image in a state of being deviated to the hole from the best focus condition. Further, clearer hole image than the image acquired previously by high magnification, may be acceptable as the ideal image.

Thus, according to this embodiment, high-speed inspection is realized by decreasing an inspection resolution when obtaining the hole image by the image acquisition unit 20, and meanwhile, by applying super resolution image processing to the hole image as the imaging result by the super resolution image processing unit 31, thereby obtaining the super resolution image corresponding to the hole image, the inspection precision required for the hole image can be secured.

(S105: Pattern Matching)

After the super resolution image processing unit 31 performs super resolution image processing, pattern matching processing is applied to the super resolution image obtained by the super resolution image processing. The “pattern matching processing” called here, is the processing of obtaining similarity between each hole image and a previously specified reference hole image.

In order to perform such a pattern matching processing, in the control computer unit 30, first, the reference specification unit 32 performs processing of specifying the reference hole image. The “reference hole image” is the hole image as the reference for obtaining the similarity between each hole image and the reference hole image.

The reference hole image may be specified according to a hole position in a part of the area (for example, the hole image at an upper left position on a plane scanned first in this area is used as the reference hole image), or the hole image desired by an operator of the substrate inspection device may be selected as the reference hole image after the imaging result is displayed and outputted by the user interface unit 40, or the hole image (for example, the hole image corresponding to an average calculation result) introduced from a plurality of hole images may be used as the reference hole image. The image obtained by applying the super resolution image processing to the hole image, may be used as the reference hole image.

Thus, the reference hole image is specified based on the hole image obtained by the image acquisition unit 20. This is because characteristic of the optical system, etc., constituting the image acquisition unit 20 is reflected on the reference hole image, if the hole image obtained by the image acquisition unit 20 is based. Namely, for example the characteristic of the optical system, etc., is reflected on the reference hole image, unlike the case that the design data is based, and therefore high precision processing is achieved for obtaining the similarity between each hole image actually obtained via the optical system, etc., and the reference hole image. However, when deterioration of the image due to the optical system is small enough to be ignored, the image obtained separately in a best focus condition, may be used as the reference hole image, or the image acquired by high magnification may be used, and further a design image may be used as the reference hole image.

Note that the reference hole image specified once is used in common among a plurality of partial areas.

After the reference hole image is specified, in the control computer unit 30, pattern matching processing between the reference hole image and each hole image is performed thereafter by the pattern matching unit 33. Namely, the pattern matching unit 33 obtains the similarity between each hole image and the reference hole image.

The pattern matching unit 33 obtains the similarity between each hole image and the reference hole image, using a specific correlation function. The “correlation function” is the function used for confirming the similarity between two images (functions). For example a normalized correlation function as shown in the following formula (2) is given as the specific correlation function used by the pattern matching unit 33.

$$\begin{matrix}[ Formula 2 ] & \\ R ( i , j ) = \frac{{\sum }_{x = 0}^{L - 1} {\sum }_{y = 0}^{K - 1} ( w ( x , y ) - \overline{w} ) ( f ( x + i , y + j ) - \overline{f} ( i , j ) )}{{{[ {\sum }_{x = 0}^{L - 1} {\sum }_{y = 0}^{K - 1} ( w ( x , y ) - \overline{w} ) ]}^{\frac{1}{2}} [ {\sum }_{x = 0}^{L - 1} {\sum }_{y = 0}^{K - 1} {( f ( x + i , y + j ) - \overline{f} ( i , j ) )}^{2} ]}^{\frac{1}{2}}} & ( 2 )\end{matrix}$$

Note that in formula (2), w indicates a function for the reference hole image having L×K pixel, and f indicates the hole image to be inspected having pixel of L×K or more.

By using such a normalized correlation function, the similarity between each hole image and the reference hole image, is expressed by a numerical value (called “score” hereafter). Specifically, as the similarity is higher, a score close to a prescribed value showing a case of complete matching (in this case, 1000 magnified value is used, showing that there is a similarity when the value is close to “1000”) can be obtained. Namely, by the pattern matching using the normalized correlation function, the similarity between each hole image and the reference hole image is converted to numerals (quantified). Note that when a plurality of super resolutions are used (S104 super resolution a, and super resolution b), a processed image of higher score is used as the image for inspection.

Then, if the score thus obtained (namely a quantification result) is used as an index, a degree of the similarity between the hole image and the reference hole image can be objectively and quantitatively judged. Grades of the hole image whose score is obtained, is judged as follows: specifically, when the score of complete matching is “1000”, the hole shape is “excellent” if the score obtained by quantization is “900” or more for example, the hole shape is “proper” if the score is “700” or more and less than “900” for example, and the hole shape is “improper” if the score is less than “700” for example.

Thus, in this embodiment, proper/improper (whether or not deformation occurs) in the hole shape of the hole image whose score is obtained, is objectively and quantitatively judged, by using the score as an index regarding each hole image obtained by the pattern matching using the normalized correlation function.

(S106: Edge Detection)

After the pattern matching unit 33 performs the pattern matching processing, subsequently processing of specifying the edge of each hole image is performed by the edge detection unit 34. The “edge” of the hole image is a boundary between an image portion showing the hole and an image portion showing a substrate, and is an image portion corresponding to a plane position of a side wall of the hole.

However, in the processing performed after the pattern matching processing, a processing object having the score of a specific value (for example, “700”) obtained by the pattern matching, is considered to be used. If the score is less than the specific value, deformation occurs in the hole shape, and the hole shape is judged to be “improper”, and therefore the hole is not suitable for a practical use. Accordingly, such a hole is excluded from the processing object, to thereby achieve practicability of the inspection result and reduce the processing load thereafter.

Namely, the edge detection unit 34 applies processing of specifying the edge, to each hole image that matches the reference hole image.

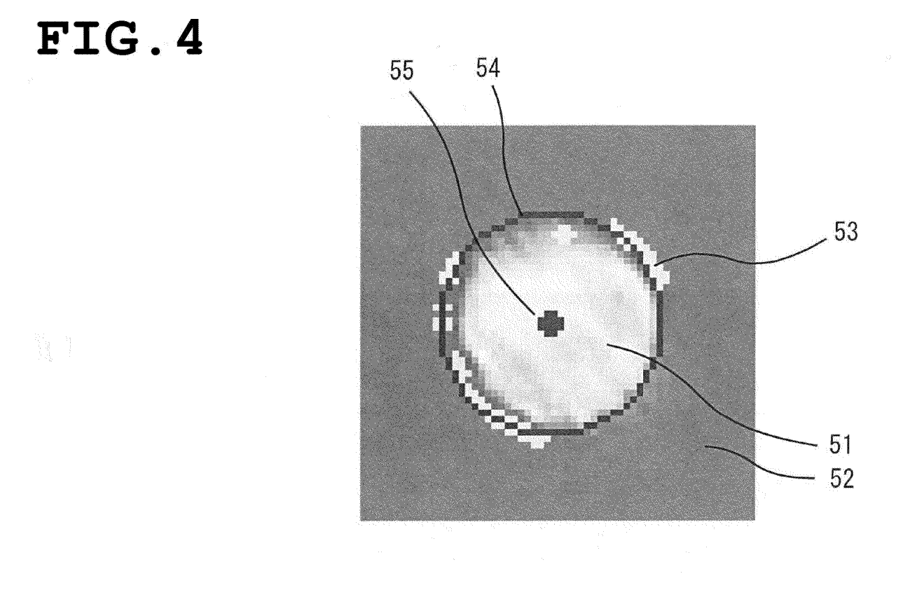

FIG. 4 is an explanatory view showing a specific example of edge specification and a circular fitting.

FIG. 4 shows a specific example of a certain one hole image. As shown in the figure, the hole image is constituted of an image portion 51 showing a hole, and an image portion 52 showing a substrate. The edge detection unit 34 applies processing of specifying the edge, to each of such hole images. Note that the hole image which is the processing object actually, is the image obtained after super resolution image processing.

Specification of the edge may be performed by focusing on a pixel value of each pixel (particularly brightness) constituting the hole image, and detecting apart where a variation level of the pixel values between neighboring pixels is a specific threshold value or more. Further, the specification of the edge may also be performed by using a publicly-known edge detection technique.

By performing such a processing, the edge detection unit 34 detects a plurality of parts where the variation level of the pixel values is the specific threshold value or more, as an edge parts 53 in the hole image. The detected edge parts 53 are not required to exist over the whole circumference of the hole. This is because there is also a case that the variation of the pixel values does not clearly appear even in the edge portion, depending on an imaging state of the hole image. Regarding the detected edge parts 53, the number of the edge parts is increased in some cases, by deepening the focal depth of the optical system by interposing the objective lens 22a of low magnification when obtaining the hole image.

(S107: Circular Fitting)

After the edge detection unit 34 performs the processing of specifying the edge, subsequently fitting processing is performed for specifying a hole outline from the edge specified by the fitting unit 35. The “hole outline” is the outline of a planar hole shape of the hole image, and can be obtained by connecting all edge parts of the hole image (including an undetected edge).

The fitting processing of specifying the hole outline is performed as follows. First, a coordinate value of the edge part 53 detected by the edge detection unit 34 is recognized, regarding the hole image subjected to the fitting processing. Then, a circumference along all recognized coordinate values is obtained using least-squares method for example. Not the least-squares method but other publicly-known fitting technique may also be used.

As shown in FIG. 4, the circumference thus obtained is a hole outline 54 for the hole image subjected to the fitting processing. Since the hole having a score which is obtained by pattern matching processing and which is less than a specific value, is excluded from the processing object, and the least-squares method is used for the fitting processing, the hole outline 54 is approximately a circular shape.

When such an approximately circular-shaped hole outline 54 is obtained, subsequently the fitting unit 35 obtains a central position 55 of this hole outline 54. The central position 55 can be obtained by using a publicly-known mathematical technique for example. Thus, regarding the hole image to be processed, the coordinate value of the central position 55 is clarified.

When the central position 55 of the hole outline 54 is obtained, the fitting unit 35 further obtains the size of this hole outline 54. Specifically, since the hole outline 54 has approximately circular shape, a maximum diameter of the hole outline 54 is obtained as the size of the hole outline 54. The maximum diameter can also be obtained by using the publicly-known mathematical technique. Thus, regarding the hole image to be processed, the value of its maximum value is clarified, in addition to the coordinate value of the central position 55.

Thus, in this embodiment, the super resolution image whose matching score is high in the pattern matching processing is used, and the edge detection unit 34 detects the edge parts 53 for the super resolution image (hole image), and further the fitting unit 35 applies fitting processing thereto, to thereby obtain approximately circular-shaped hole outline 54 from the edge parts 53.

If such a circular fitting is performed, it is extremely easy to obtain the central position 55 of the hole outline 54 and obtain the maximum diameter of the hole outline 54 with high precision.

### (S108: Proper/Improper Judgment)

By undergoing the abovementioned series of processing step, regarding each hole image obtained by the image acquisition unit 20, the matching score obtained by the pattern matching processing, and the coordinate value of the central position and the value of the maximum diameter obtained from the fitting processing, can be clarified. The detection unit 30b judges the proper/improper of each hole image by comparing a clarified result and a previously set threshold value. Specifically, the shape inspection unit 36 of the inspection unit 30b judges the proper/improper of the hole shape of each hole image (whether or not the deformation occurs, etc.) using the matching score as the index, for example in such a manner that if the score is “900” or more, the hole shape is “excellent”, and if the score is “700” or more and less than “900”, the hole shape is “proper”, and if the score is less than “700”, the hole shape is “improper”. Further, the size inspection unit 37 of the inspection unit 30b judges the proper/improper of a formation position of each hole image using a central position coordinate value as an index (whether or not a positional deviation occurs, etc.) for example in such a manner that if the formation position is in a range of ±2.0 μm of the design value, the formation position is “proper”, and if it is not in this range, the formation position is “improper”. Moreover, the shape inspection unit 36 judges proper/improper of a formation size of each hole image (whether or not a size deviation occurs, etc.) using the value of the maximum diameter as an index, for example in such a manner that if the formation size is in a range of ±3.0 μm of the design value, the formation size is “proper”, and if it is not in this range, the formation size is “improper”. Note that if any one of the matching score, the central position coordinate value, or the maximum diameter is “improper”, the judgment result of this hole image is “improper”.

### (S109, S110: Display of the Result)

The judgment result thus obtained by the inspection unit 30b is displayed and outputted to the operator of the substrate inspection device from the user interface unit 40. A specific mode of the display/output of the judgment result is not particularly limited, if the operator of the substrate inspection device can recognize the judgment result. However, the following mode can be considered as a specific example.

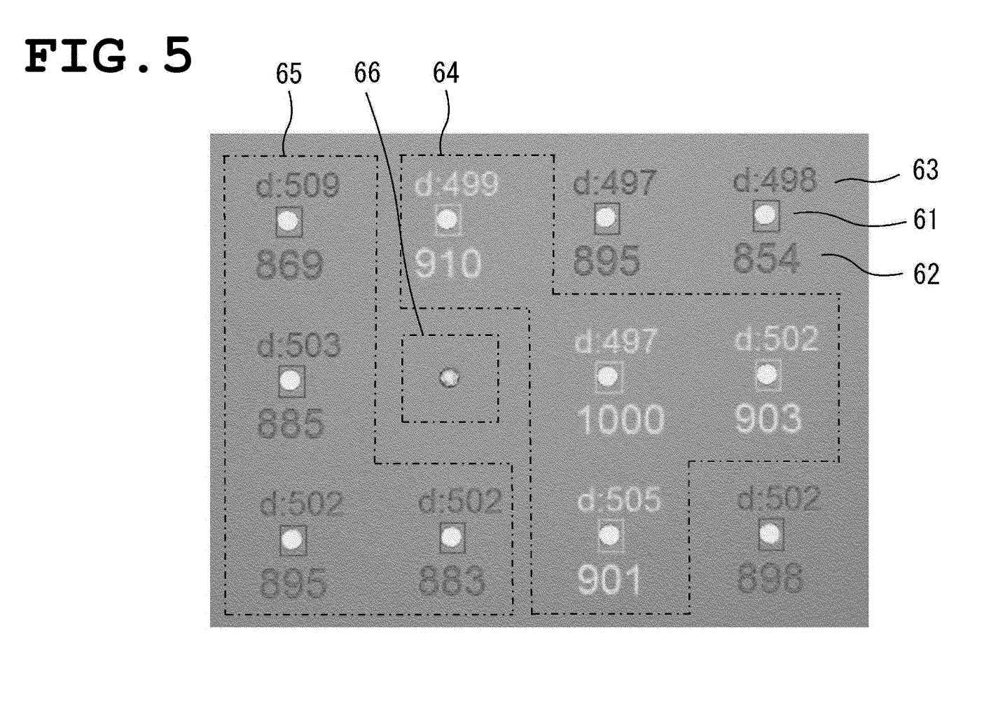

FIG. 5 is an explanatory view showing a specific example of a display/output mode of the proper/improper judgment result of each hole image.

According to the display/output mode in the example of the figure, a matching score 62 and a maximum diameter value 63 of a hole image 61 are displayed and outputted, in addition to the display/output of each hole image 61. Each hole image 61 is displayed and outputted in a state of being arranged at a position where it is arranged, and if deviation, etc., occurs at the position where it is arranged, such a deviation affects a display/output result. At this time, the central position coordinate value of each hole image 61 may also be displayed and outputted, together with the matching score 62 and the maximum diameter value 63.

Further, in the display/output mode in the example of figure, each hole image 61 and the matching score 62 and the maximum diameter value 63 are also displayed and outputted together so as to be identified according to the judgment result obtained by the inspection unit 30b. Specifically, for example if the judgment result shows “excellent”, this judgment result is displayed and outputted by “green color” and arranged into group 64, and for example if the judgment result shows “proper”, this judgment result is displayed and outputted by “red color” and arranged into group 65, so that each judgment result is displayed and outputted so as to be identified. However, a reference, etc., of a display color and grouping may be suitably set if the judgment result can be identified by the detection unit 30b, and is not limited to the example given here.

When the hole image 61 whose matching score is less than a specific value (for example “700”) is excluded from an object subjected to processing performed after the pattern matching processing, the hole image 61 is displayed and outputted and classified into group 66 without displaying the matching score 62 and the maximum diameter value 63, and so as to be distinguished from “proper” judgment and “improper” judgment.

If the abovementioned display/output in the display/output mode is performed by the user interface unit 40, the operator of the substrate inspection device can easily and surely recognize the judgment result of each hole image 61 by the inspection unit 30b. More specifically, by using the display/output mode that can be identified by the display color, etc., the operator of the substrate inspection device can easily and surely recognize the judgment result of “excellent”, “proper”, and “improper”. Further, by using the display/output mode of displaying and outputting the matching score 62 and the maximum diameter value 63 together, the operator of the substrate inspection device can easily and objectively recognize the suitability of the hole shape and the formation size, etc., respectively. Moreover, such an individual hole inspection result is corrected, and for example in view of a definition of excellent ratio and the number of improper judgments, etc., a usable area can be determined according to success of the substrate itself or success of hole density (S111).

### 4. Procedure of the Substrate Manufacturing Method

The substrate manufacturing method using the abovementioned substrate inspection method, namely a processing procedure of the substrate manufacturing method according to the present invention will be described next.

In manufacturing the substrate, a substrate formation step is executed first. The substrate formation step is the step of constituting the substrate which is configured to have a plurality of holes formed on a plate-shaped material so as to extend over front and rear surfaces of the plate-shaped material. Specifically, it can be considered that a photosensitive glass or a photosensitive crystallized glass is used as a base material, and a substrate having a plurality of fine holes is constituted as described in the item of “1. Substrate to be inspected”. The substrate thus constituted can be utilized as a printed circuit board, an interposer, an integrated passive device (IPD), a liquid discharge nozzle for an ink jet head, and a substrate for electronic amplification constituting a gas electronic amplifier (GEM).

Thereafter, proper/improper hole formed on the substrate having a plurality of fine holes, is inspected by the procedure descried in the item of “3. Procedure of the substrate inspection method”, using the substrate inspection device described in the item of “2. Constitutional example of the substrate inspection device”. Specifically, inspection is applied to the substrate having a plurality of fine holes, through an image acquisition step of picking-up an image of the holes formed on the substrate from one surface side of the substrate to be inspected (S103); a super resolution image processing step of obtaining a super resolution image by applying super resolution image processing to the hole image thus obtained (S104); a reference specification step of specifying a reference hole image (S105); a quantifying step of obtaining a similarity between each hole image and the reference hole image and converting (quantifying) it to numerals (S105 to S107); and an inspection step of inspecting proper/improper hole formed on the substrate based on a processing result of each step (S108). Further, the inspection step (S108) includes a formation inspection step of judging proper/improper hole shape using the quantification result (S105) of each hole image as an index; and a size inspection step of obtaining a hole outline in the hole image by fitting processing (S107), and judging proper/improper state of at least one of the hole size and the hole formation position, using the size of the hole outline.

As a result of undergoing such a series of steps respectively, other substrate excluding the substrate judged to be “improper” (namely the substrate judged to be “excellent” or “proper”) in the inspection step (S108) is delivered as a proper product.

Accordingly, for example, even in a case of manufacturing the substrate having a plurality of holes (several thousands to several millions or more holes) of 100 μm level or less formed on a plate-shaped material having translucency like a photosensitive glass as a base material, only the substrate having the holes whose defect can be speedily inspected with high precision, and judged to be a proper product by this inspection, can be delivered.

Namely, even in a case that the substrate manufactured and delivered by the substrate manufacturing method of this embodiment, has a plurality of holes (several thousands to several millions or more holes) of 100 μm level or less, with a plate-shaped material having translucency like a photosensitive glass as a base material, defect, etc., is not generated in each hole.

### 5. Effect of this Embodiment

According to the substrate inspection method, the substrate manufacturing method, and the substrate inspection device described in this embodiment, the following effect can be obtained.

According to this embodiment, the reference hole image for a plurality of holes is specified from the imaging result of the plurality of holes formed on the substrate to be inspected, and the similarity between each hole image as the imaging result of the plurality of holes and the reference hole image is obtained and quantified by pattern matching processing using a prescribed correlation function, and the quantification result is used as an index, to thereby judge the proper/improper hole shape of each of the plurality of holes. Namely, in this embodiment, by reflecting the characteristic of the optical system, etc., on the reference hole image, the proper/improper hole shape in the scored hole image, is objectively and quantitatively judged by using the score (matching score) as an index, which is the quantification result obtained by the pattern matching processing performed for the similarity between each hole image and the reference hole image, while achieving the high precision of the processing of obtaining the similarity between each hole image actually obtained through the optical system, etc., and the reference hole image.

Therefore, according to this embodiment, for example even when the hole size becomes finer to 100 μm level or less, the similarity between each hole image and the reference hole image is quantified, and therefore whether or not the deformation (distortion, etc.) occurs in each hole shape can be judged objectively and quantitatively by using the score (matching score) which is the quantification result as an index, thus realizing a high precision defect inspection applied to each hole image.

In addition, according to this embodiment, for example the hole size becomes finer to 100 μm level or less, and a total number of holes are progressively increased as the size of the substrate is increased, which is increased as the hole size becomes finer, and even in this case, the reference hole image on which the characteristic of the optical system, etc., is reflected, and each hole image can be compared, and correction processing, etc., is not required to be applied to each hole image. Therefore, the defect inspection can be easily and clearly performed, and much processing time is not required therefore.

As described above, in this embodiment, even when the total number of the holes is progressively increased due to the finer hole size and increase in the size of the substrate, the defect inspection of each hole can be speedily performed with high precision, and can be easily performed with high precision, for the substrate having a plurality of holes.

Further, according to this embodiment, regarding each hole image obtained from the substrate to be inspected, the hole outline in this hole image is obtained by specific fitting processing, and regarding each of the plurality of holes on the substrate, at least one of the hole size and the hole shape position is judged using the size of the hole outline. Then, when the hole outline is obtained, as the specific fitting processing, not the fitting processing of simply using the circular shape, but the fitting processing of using the least-squares method is performed.

Therefore, according to this embodiment, the hole outline is obtained through the fitting processing, and therefore the hole size and the hole formation position, etc., can be extremely easily and precisely specified, compared with a case that the hole size and the hole formation position, etc., are specified directly from the hole image without obtaining the hole outline. In addition, when the fitting processing is performed, not the fitting processing of simply using the circular shape, but the fitting processing of using the least-squares method is performed. Therefore, the hole outline thus obtained is a result of reflecting an actual hole shape obtained by picking-up the hole image, which is extremely suitable for obtaining the hole size and the hole shape position, etc., with high precision.

Further, according to this embodiment, only the hole image whose score obtained by the pattern matching processing is a specific value or more (for example “700”) or more, is used as the processing target of the fitting processing performed thereafter.

Therefore, according to this embodiment, the hole image in which deformation, etc., occurs in the hole shape and having the score of less than the specific value, is excluded from the processing object, to thereby reduce the processing load after the pattern matching processing, compared with a case that such an exclusion is not performed.

Further, in this embodiment, the super resolution image is obtained, corresponding to the image picked-up via the optical system including the microscope having the objective lens of higher magnification (specifically 40 to 100 magnifying powers) than a specific magnification, by applying super resolution image processing by deconvolution operation, to the hole image picked-up via the microscope 22 having the objective lens 22a of the specific magnification (specifically low magnification of 5 to 20 magnifying powers), and the proper/improper hole formed on the substrate is inspected using this super resolution image. Namely, according to this embodiment, an inspecting resolution is decreased when the hole image is obtained, and meanwhile, super resolution image processing is applied to the hole image as the imaging result, to thereby obtain the super resolution image corresponding to the hole image, and detection accuracy required for the hole image is secured.

Therefore, according to this embodiment, even when the substrate having a plurality of holes (several thousands to several millions or more holes) is the object to be inspected, it is possible to practically cope with inspection time, etc., unlike a technique of requiring positioning of a pin for directly inserting a gage pin into the hole. Further, according to this embodiment, even when the substrate having translucency like the photosensitive glass is the object to be inspected, a suitable inspection can be performed unlike a case of observing a transmitted light.

Further, according to this embodiment, (1) the inspection resolution is decreased, for example when obtaining the hole image by interposing the objective lens 22a of low magnification of 5 to 20 magnifying powers, and therefore increase of the number of partial areas to be imaged can be suppressed even if the size of the substrate to be inspected becomes larger, thus realizing a high-speed inspection. Further, according to this embodiment, (2) the focal depth of the optical system can be suppressed from becoming shallow by suppressing the lens numerical aperture (NA) to be low, for example by interposing the objective lens 22a of low magnification of 5 to 20 magnifying powers, and therefore allowance can be increased for blurring of the hole image as a result of imaging, compared with a case of high magnification. Therefore, a high precision autofocus mechanism is not required to be added to the imaging optical system 23, thus not inviting the increase of the size of the optical system and increase of the cost, etc. Moreover, according to this embodiment, (3) the focal depth of the optical system is suppressed from becoming shallow by interposing the objective lens 22a of low magnification of 5 to 20 magnifying powers, and therefore the difference of the kind of the hole such as a through hole or a conductive member filling hole (via hole), etc., can be flexibly and suitably cope with. Namely, the defect inspection with high precision can be realized, even in a case of any kind of the hole formed on the substrate.

As described above, in this embodiment, even when the number of total holes is progressively increased due to finer hole size and increase in the size of the substrate, the defect inspection of each hole can be speedily performed with high precision, and can be easily performed with an inexpensive structure, for the substrate having a plurality of holes.

### 6. Modified Example, Etc.

Embodiments of the present invention are described above. However, the abovementioned disclosed contents show exemplary embodiments of the present invention. Namely, a technical range of the present invention is not limited to the abovementioned exemplary embodiments.

For example, in this embodiment, hole formation mode and proper/improper judgment reference, etc., are specifically shown by numerical values in the substrate to be inspected. However, these numerical values are simply given as an example, and can be suitably set as needed.

Namely, the present invention is characterized in that the observation of further low magnification can be performed, and the evaluation can be converted to numerical values (quantified) to realize objective evaluation, by utilizing the super resolution, pattern matching, and fitting processing. Accordingly, even in a case of the image of high magnification responding to a required inspection precision, the objective inspection judgment can be realized by the abovementioned quantification. Further, even in a case of a pattern in which L&S, dots, holes, and other shapes are repeated, a fitting graphic may be suitably selected for the other shape. In addition, even in a case of SEM image and AFM image with a repeated pattern like imprint, the similar technique can be used.

What is claimed is:

1. A substrate inspection method, for inspecting a substrate having a plurality of holes formed on a plate-shaped material so as to extend over front and rear surfaces of the plate-shaped material, comprising:
an image acquisition step of picking-up an image of a plurality of holes formed on the substrate by imaging from one surface side of the substrate, and obtaining a hole image of each hole;
a reference specification step of specifying a reference hole image of the plurality of holes from an imaging result obtained by the image acquisition step;
a quantification step of obtaining and quantifying a similarity between each hole image being the imaging result obtained by the image acquisition step, and the reference hole image, by pattern matching processing using a specific correlative function; and
a shape inspection step of judging proper/improper hole shape of each of the plurality of holes using a quantification result of each hole image obtained by the quantification step as an index.

2. The substrate inspection method according to claim 1, further comprising a size inspection step of obtaining a hole outline of each hole image by fitting processing, the hole image being the imaging result obtained by the image acquisition step, and making a proper/improper judgment for at least one of a hole size and a hole shape position of each of the plurality of holes, using the hole outline.

3. The substrate inspection method according to claim 1, wherein the substrate has the holes formed on a plate-shaped photosensitive glass material with a thickness of 1 mm or less, and the holes are through holes or conductive material filling holes with a diameter of 100 μm or less.

4. The substrate inspection method according to claim 1, wherein when the image of the plurality of holes are picked-up via an optical system including a microscope having an objective lens of a specific magnification in the image acquisition step, super resolution image processing is applied to the hole image obtained by the image acquisition step, to thereby obtain a super resolution image corresponding to an image picked-up via an optical system including a microscope having an objective lens of higher magnification than the specific magnification, as the imaging result obtained by the image acquisition step.

5. A substrate manufacturing method,
comprising:
a substrate formation step of constituting a substrate having a plurality of holes formed on a plate-shaped material so as to extend over front rear surfaces of the plate-shaped material;
an image acquisition step of obtaining a hole image of each hole by imaging the plurality of holes formed on the substrate from one surface side of the substrate constituted in the substrate formation step;
a reference specification step of specifying a reference hole image of the plurality of holes from an imaging result obtained by the image acquisition step;
a quantification step of obtaining and quantifying a similarity between each hole image and the reference hole image, each hole image being the imaging result obtained by the image acquisition step by pattern matching processing using a specific correlative function; and
a formation inspection step of judging proper/improper hole shape of each of the plurality of holes using a quantification result of each hole image obtained by the quantification step as an index.

6. The substrate manufacturing method according to claim 5, further comprising a size inspection step of obtaining a hole outline of each hole image by fitting processing, the hole image being the imaging result obtained by the image acquisition step, and making a proper/improper judgment for at least one of a hole size and a hole shape position of each of the plurality of holes, using the hole outline.

7. The substrate manufacturing method according to claim 5, wherein the substrate has the holes formed on a plate-shaped photosensitive glass material with a thickness of 1 mm or less, and the holes are through holes or conductive material filling holes with a diameter of 100 μm or less.

8. The substrate manufacturing method according to claim 5, wherein when the image of the plurality of holes are picked-up via an optical system including a microscope having an objective lens of a specific magnification in the image acquisition step, super resolution image processing is applied to the hole image obtained by the image acquisition step, to thereby obtain a super resolution image corresponding to an image picked-up via an optical system including a microscope having an objective lens of higher magnification than the specific magnification, as the imaging result obtained by the image acquisition step.

9. A substrate inspection device for inspecting a substrate having a plurality of holes formed on a plate-shaped material so as to extend over front and rear surfaces of the plate-shaped material, the device comprising:
an image acquisition unit configured to obtain a hole image of each hole by imaging the plurality of holes formed on the substrate from one surface side of the substrate;
a reference specification unit configured to specify a reference hole image of the plurality of holes from an imaging result obtained by the image acquisition unit;
a quantification unit configured to obtain and quantify a similarity between each hole image and the reference hole image by pattern matching processing using a specific correlative function, each hole image being the imaging result obtained by the image acquisition unit; and
a shape inspection unit configured to judge proper/improper hole shape of each of the plurality of holes using a quantification result of each hole image obtained by the quantification unit as an index.

10. The substrate inspection device according to claim 9, further comprising a size inspection unit of obtaining a hole outline of each hole image by fitting processing, the hole image being the imaging result obtained by the image acquisition unit, and making a proper/improper judgment for at least one of a hole size and a hole shape position of each of the plurality of holes, using the hole outline.

11. The substrate inspection device according to claim 9, wherein the substrate has the holes formed on a plate-shaped photosensitive glass material with a thickness of 1 mm or less, and the holes are through holes or conductive material filling holes with a diameter of 100 μm or less.

12. The substrate inspection device according to claim 9, wherein when the image of the plurality of holes are picked-up via an optical system including a microscope having an objective lens of a specific magnification in the image acquisition unit, super resolution image processing is applied to the hole image obtained by the image acquisition unit, to thereby obtain a super resolution image corresponding to an image picked-up via an optical system including a microscope having an objective lens of higher magnification than the specific magnification, as the imaging result obtained by the image acquisition unit.
